(19) United States
(12) Patent Application Publication
(10) Pub. No.: US 2013/0251235 A1
(43) Pub. Date: Sep. 26, 2013

(54) SYSTEM FOR HIGH SPEED PROCESSING OF CURRENCY NOTES AND SLOT TICKETS

(71) Applicant: CASHSCAN CORP., Brooklyn, NY (US)

(72) Inventor: JACOB LAX, Brooklyn, NY (US)

(73) Assignee: CASHSCAN CORP., Brooklyn, NY (US)

(21) Appl. No.: 13/832,961

(22) Filed: Mar. 15, 2013

Related U.S. Application Data
(60) Provisional application No. 61/612,993, filed on Mar. 20, 2012.

(51) Int. Cl. G06Q 40/02

(52) U.S. Cl. CPC G06Q 40/02
USPC 382/138

(57) ABSTRACT

A system is provided for automatically processing and sorting documents related to gaming. The system includes a computer in duplex communication with a scanner having an entrance hopper into which a stack of currency notes and slot tickets are deposited and first and second exit locations into which currency notes and slot tickets are sorted. The system obtains the value of the document directly by optically identifying each value character from a scanned image of the document. The system then sorts the documents by whether the value characters are identified or not, and provides total value and quantity data for all documents identified.

### CROSS-REFERENCE TO RELATED APPLICATION

This application claims the benefit of provisional patent application Ser. No. 61/612,993 filed in the United States Patent and Trademark Office on Mar. 20, 2012.

### BACKGROUND OF THE INVENTION

1. Field of the Invention

This invention relates generally to automated systems for processing documents, and more particularly, to an automated system for high speed processing of documents of the type used in gaming, such as foreign and domestic currency notes, slot tickets and the like, containing a printed value and/or a bar code validation number. The system utilizes an automated apparatus similar to the types disclosed in U.S. Pat. No. 6,626,298 and U.S. Pat. No. 8,050,485, which have been modified to process a mixed stack of documents in an accurate, efficient, versatile and high speed manner for identifying the value of each document and separating out from the stack those documents having unidentified currency values, and allowing a user to manually input currency values for the unidentified documents. All without the necessity of forwarding each document to a remote location, thus providing quick and accurate balance information for the entire stack of documents.

Casinos and other types of gaming establishments utilize large numbers of paper documents such as foreign and domestic currencies and betting slips, which must be read and the read data converted for display, validation, manipulation and storage. While those tasks can be done manually, manual handling and sorting of such documents is time consuming, labor intensive and may result in inaccuracies.

Clearly, there is a need for a system of performing those functions with an automated apparatus that can be connected directly to a computer for displaying, validating and/or manipulating the value data as necessary. However, to be commercially successful, the system upon which the processing is performed must be able to reliably scan the printed side of the document, quickly compress and transfer the data to a computer, read the information printed thereon, ascertain the currency value of the document and convert the scanned information into a format where it can be displayed, validated, manipulated and stored, and then quickly notify the scanner to sort the document appropriately. The system must be able to operate in duplex communication mode between the scanning terminal and the computer for offering high-speed bi-directional communication. The scanning must be executed on a terminal capable of accepting stacks of mixed documents for eliminating manual sorting and capable of producing high-resolution images. The computer must be capable of identifying the value of the document, tolerant of image contrast apparent with soiled currency, and continually up to date with all new foreign and domestic currencies and bar-code validation numbers.

2. Description of the Related Art

The apparatus disclosed in U.S. Pat. No. 6,626,298 is designed for high speed automated processing of currency bills. It utilizes an improved mechanical transport system, multiple scanning devices for information reading and sophisticated digital signal processing. It employs parallel 32-bit data processing units for increased speed. An 8-bit control circuit tracks the currency bills as they move through the apparatus, accurately regulates transport motor speed and operates the collection bin gates. That patent is incorporated herein by reference. The reader is referred to that patent for detailed information as to the operation of the apparatus disclosed therein.

The apparatus disclosed in U.S. Pat. No. 8,050,485 is designed for high speed automated processing of gaming documents containing a printed value and a bar-code validation. It employs obtaining the value of the document by optically identifying each value character from a scanned image of the document. A plurality of templates are stored each representative of a possible character of the value. Optical character recognition is used to identify each value character image by comparing each of the stored templates in turn with the image. That patent is incorporated herein by reference. The reader is referred to that patent for detailed information as to the operation of the apparatus disclosed therein.

While these units may be suitable for the particular purpose employed, or for general use, they would not be as suitable for the purposes of the present invention as disclosed hereafter.

It is, therefore, a primary object of the present invention to provide a system for high speed processing of documents related to gaming without the necessity of forwarding the currency image or validation number to a remote location to obtain the value of the document.

It is another object of the present invention to provide a system for high speed processing of documents that can be performed on a fully automated system capable of scanning the printed side of the document to create an image, compressing the image, transferring the image to a computer within the system, locating and accurately reading the value information from the image and converting same into a format for display, validation, manipulation and/or storage on the computer in an efficient and high speed manner.

It is another object of the present invention to provide a system for high speed processing of documents capable of quickly and accurately identifying a value for each document deposited within a mixed stack of foreign and domestic currency, slot tickets, coupons, vouchers, and the like.

It is another object of the present invention to provide a system for high speed processing of documents capable of identifying the value printed on the document using optical character recognition and then converting same to an ASCII format through the use of templates which are compared to each of the characters.

It is another object of the present invention to provide a system for high speed processing of documents capable of instantaneously calculating and displaying a total value for all documents deposited.

It is another object of the present invention to provide a system for high speed processing of documents capable of allowing unidentified documents to be electronically viewed by the user and manually entered for immediate reconciliation.

It is another object of the present invention to provide a system for high speed processing of documents capable of being continually updated to accommodate new currencies, slot ticket fonts and bar code types.

It is another of the present invention to provide a system for high speed processing of documents that can process documents whether they are orientated right side up or upside down.

### BRIEF SUMMARY OF THE INVENTION

In accordance with one aspect of the present invention, a method is provided for automatically processing documents, including currency notes and slot tickets related to gaming, of the type having value characters printed on a side thereof, using a scanner having first and second exit locations and operating in duplex communication with a computer. The method includes depositing a stack of documents within the scanner. The method includes scanning the printed side of each document and storing an image of the scanned printed side of each document including the value characters. The document image is compressed and then stored within the scanner. The stored image is transferred from the scanner to the computer. The computer processes the stored image to identify the value of each of the value characters of the compressed document image. The computer generates signals indicating whether the value characters of the stored document image are identified or not identified. The signals are then transmitted from the computer to the scanner. The scanner receives the signals indicating whether the value characters of the stored image are identified or not identified and then sorts the documents in a selected one of a first exit location, when the value characters of the stored document image are identified, and a second exit location, when the value characters are not identified.

The step of depositing a stack of documents within the scanner includes repeating the steps above for those documents sorted into the second exit location when the value is not identified.

The step of processing the stored image by the computer includes the step of storing each of the document images when the data value characters are not identified.

The method also includes the steps of viewing each stored image when the data value characters are not identified and reconciling each document image by manually entering the value of each data value character not identified.

The method further includes the step of storing the value of each value character identified and each value character manually entered.

The method further includes the step of displaying the stored values of each of the value characters.

The method further includes the step of processing the stored values to display balance information including a total value for currency notes deposited, a total value for slot tickets deposited and a total value of all documents deposited.

The method further includes the step of displaying a total quantity of currency notes deposited, a total quantity of slot tickets deposited and a total value of all documents deposited. It also includes displaying a total quantity of currency notes deposited having data value characters not identified, a total quantity of slot tickets deposited having data value characters not identified and a total value of all documents deposited having data value characters not identified.

The step of storing an image of the scanned printed side of each document including the value characters further includes the step of formatting the document image as a Bitmap.

The step of compressing the document image within the scanner further includes the step of compressing the document image as a TIF file.

The step of storing the compressed document image within the scanner further includes the step of storing the TIF file.

The step of transferring the compressed document image from the scanner to the computer further includes transferring the compressed document image via a universal serial bus port.

The step of transmitting the signals from the computer to the scanner further includes transmitting the signals from the computer to the scanner via a serial interface.

The method further includes the step of programming the computer to recognize new currencies.

The documents in use by the present method have a bar coded validation number printed thereon and the method includes the steps of scanning an image of the validation number from the document. The method includes compressing the document image. The method includes saving the compressed document image. The method includes transferring the document image to the computer. The method includes converting the read validation number into validation data representative thereof. The method includes storing the validation data.

The method further includes the step of programming the computer to recognize and read new slot ticket fonts and bar code validation numbers.

The scanner of the method includes a control board and the steps further include monitoring changes in performance of the scanner by the control board. The method includes generating signals related to the changes in performance by the control board. The method includes transmitting the signals from the control board of the scanner to the computer. It also includes the step of receiving the signals from the control board by the computer, analyzing the signals to define a result, displaying the result.

In accordance with another aspect of the present invention system is provided for automatically processing documents including currency notes and slot tickets related to gaming, of the type having value characters printed on a side thereof. The system includes a scanner terminal having an entrance hopper into which a stack of currency notes and slot tickets are deposited and first and second exit locations into which currency notes and slot tickets are sorted. The system has means for scanning the printed side of each document and means for storing an image of the scanned printed side of each document including the value characters, means for compressing the document image and means for storing the compressed document image. Means are provided for transferring the compressed document image from the scanner to the computer. Means are provided for receiving signals by the scanner indicating whether the value characters of the stored image are identified or not identified. Means are provided for sorting the documents in a selected one of a first exit location, when the value characters of the stored document image are identified, and a second exit location, when the value characters are not identified.

The system has a computer in duplex communication with the scanner and provides means for receiving the compressed document image. Means are provided for processing the stored image to identify the value of each of the value characters. Means are provided for generating signals indicating whether the stored image is identified or not identified. Means are provided for transmitting the signals to the scanner.

The system includes re-depositing at least one document into the entrance hopper from the second exit location.

Means for processing the stored image by the computer includes means for storing each of the document images when the data value characters are not identified.

The system further includes means for viewing each stored image when the data value characters are not identified, and provides means for reconciling each document image by manually entering the value of each data value character not identified. It also includes means for storing the value of each value character identified and each value character manually entered.

The system also includes means for displaying the stored values of each of the value characters.

The system further includes means for processing the stored values to display balance information including a total value for currency notes deposited, a total value for slot tickets deposited and a total value of all documents deposited.

The system further includes means for displaying a total quantity of currency notes deposited having data value characters not identified, a total quantity of slot tickets deposited having data value characters not identified and a total value of all documents deposited having data value characters not identified.

The system further includes means for storing an image of the scanned printed side of each document including the value characters comprising means for formatting the document image as a Bitmap.

Means for compressing the document image within the scanner includes means for compressing the document image as a TIF file.

Means for storing the compressed document image within the scanner includes means for storing the TIF file.

Means for transferring the compressed document image from the scanner to the computer includes means for transferring the compressed document image via a universal serial bus port.

Means for transmitting the signals from the computer to the scanner includes means for transmitting the signals from the computer to the scanner via a serial interface.

The system also includes means for programming the computer to recognize new currencies.

The documents used by the system include bar coded validation numbers printed thereon and the system further includes means for scanning an image of the validation number from the document. Means are provided for compressing the document image. Means are provided for saving the compressed document image. Means are provided for transferring the document image to the computer. Means are provided for converting the read validation number into validation data representative thereof. Means are provided for storing the validation data.

The system further includes means for programming the computer for recognizing and reading new slot ticket fonts and bar code validation numbers.

The scanner of the system includes a control board and further includes means for monitoring changes in performance of the scanner by the control board. Means are provided for generating signals related to the changes in performance by the control board. Means are provided for transmitting the signals from the scanner to the computer.

The system further includes means for receiving the signals by the computer. Means are provided for analyzing the signals to define a result. Means are provided for displaying the result.

### BRIEF DESCRIPTION OF THE SEVERAL VIEWS OF THE DRAWINGS

To these and to such other objects that may hereinafter appear, the present invention relates to a system for high speed processing and sorting of documents related to gaming without the necessity of forwarding the currency image or validation number to a remote location to obtain the value of the document as described in detail in the following specification and recited in the annexed claims, taken together with the accompanying drawings, in which like numerals refer to like parts in which:

FIG. 1 is a block diagram of the system for processing documents related to gaming in accordance with the present invention;

FIG. 2 is a flow chart of the process of scanning and sorting a stack of documents with the system of the present invention;

FIG. 3 is a detailed flow chart of the process of the system of the present invention;

FIG. 4 is perspective outside view of the scanner in duplex communication with the computer of the system of the present invention; and

FIG. 5 is an image of a typical document related to gaming.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### DETAILED DESCRIPTION OF THE INVENTION

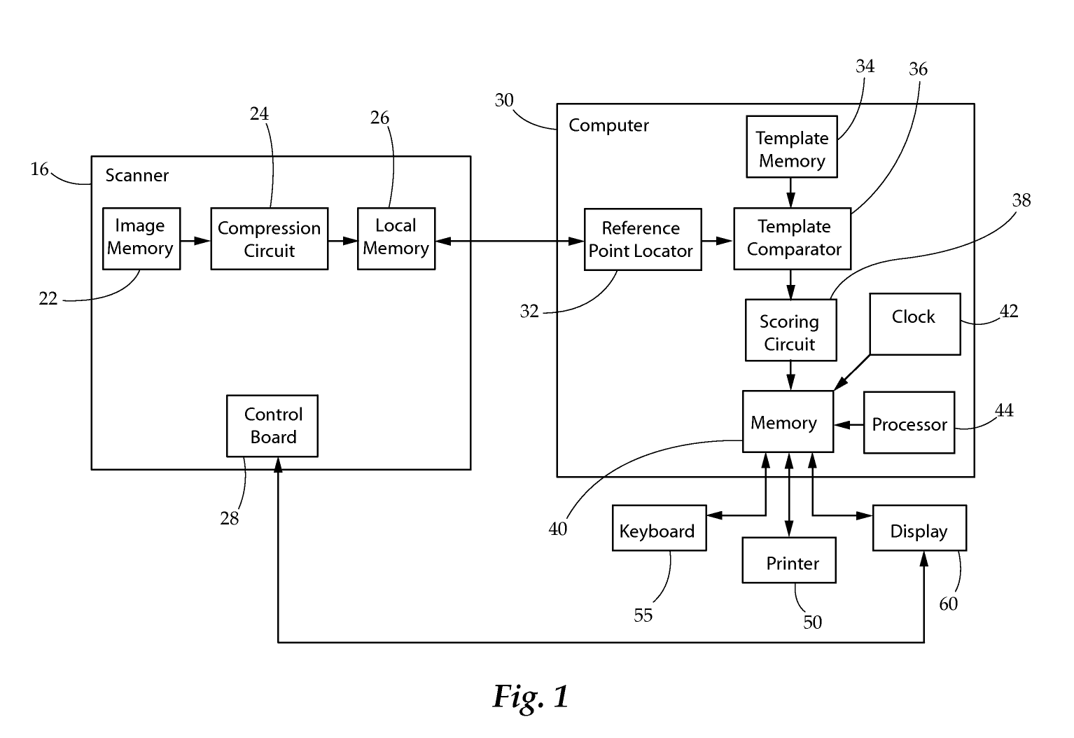

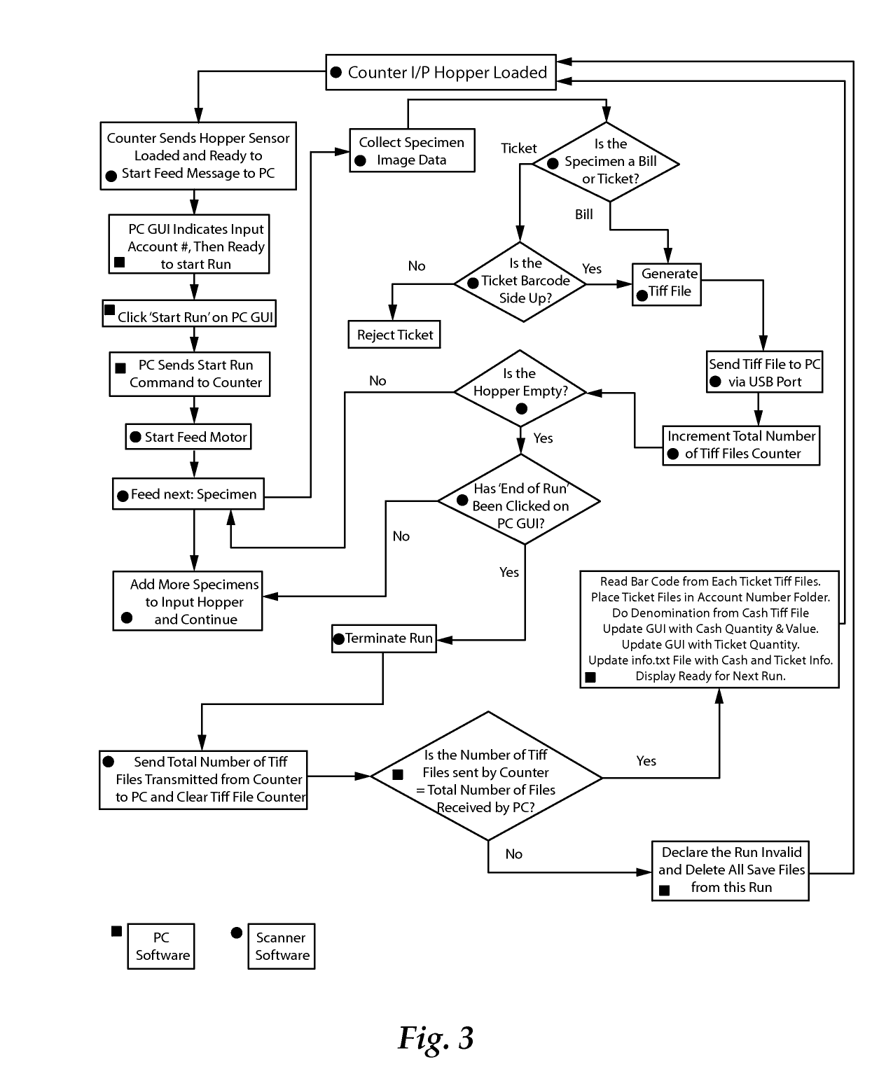

The present invention is directed to a system 10 for high speed processing of documents related to gaming as illustrated in block form in FIG. 1-4. In its broadest context, the system 10 includes a scanner 16 operating in duplex communication with a computer 30 such that information is communicated back and forth, bi-directionally, between each device.

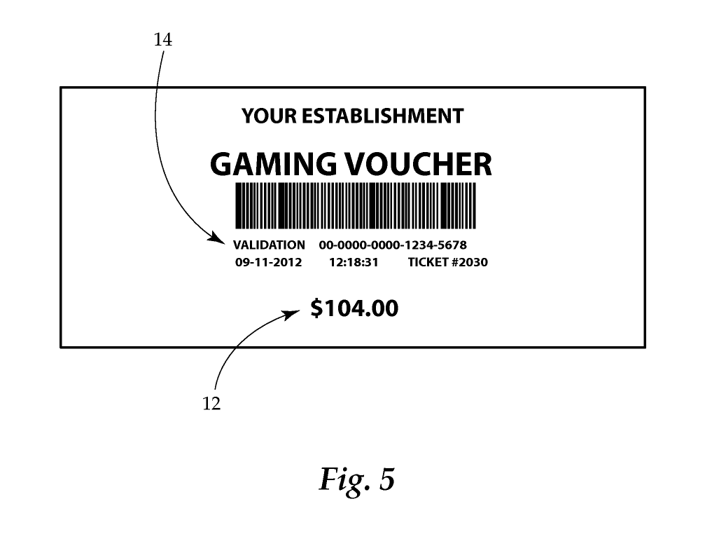

The system 10 is designed to process a stack of documents, generally designated A, such as domestic and foreign currencies, slot tickets, betting tickets, coupons, vouchers and the like, illustrated in FIG. 5 that include value characters. The value characters include a value 12, preferably a dollar value or other currency value, and/or a bar-coded validation number 14. In particular, domestic currencies include the dollar value 12 thereon, while betting tickets typically include the currency value 12 and the bar-coded validation number 14, both of which are printed on the same side of the document.

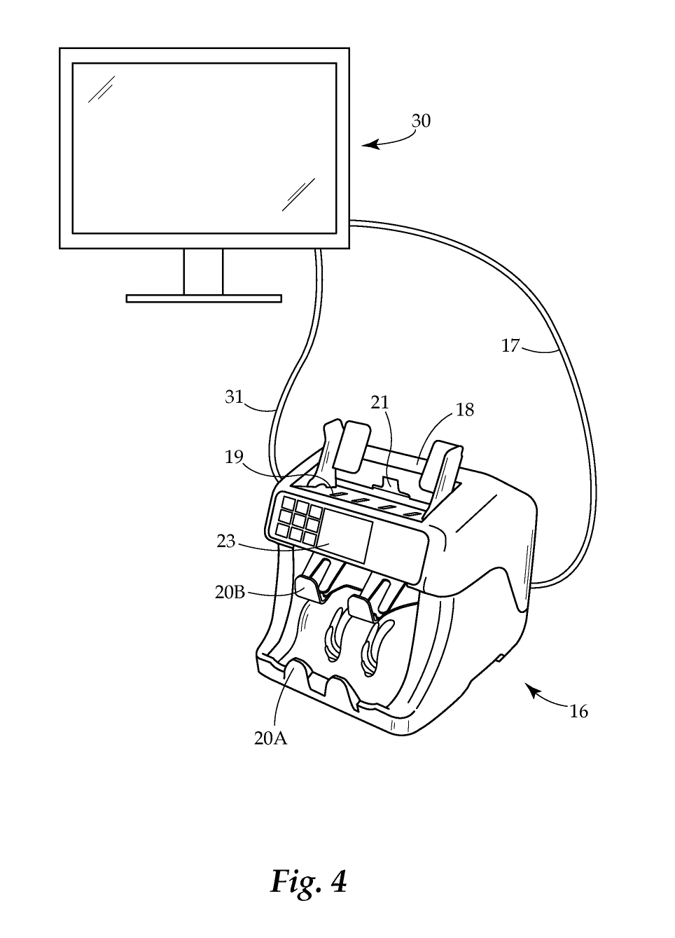

The optical scanner 16 illustrated in FIG. 4, is used for scanning the printed side of each gaming document from the stack and creating a full width medium-resolution image thereof before sorting. The scanner 16 includes an entrance hopper 18 for depositing the stack of documents therein and two exit locations 20, including a first exit location 20A and a second exit location 20B, into which the documents are sorted. The stack of documents may include a variety of domestic and foreign currencies, as well as gaming tickets and vouchers, all preferably mixed together in no specific order when deposited into the entrance hopper 18. The scanner 16 also includes a plurality of sensors 19, motors 21 and a scanner display 23, which monitor, control and signal performance of the scanner.

Referring back to FIG. 1, the document image, including the image of each character of the value 12 printed thereon, is stored after scanning in an image memory 22. The document image is originally in Bitmap format, which is approximately 1 MB in size. The document image in Bitmap format is then transferred to a compression circuit 24. The compression circuit 24 compresses the 1 MB image to approximately 20K and saves the compressed image as a TIF file. The TIF file of the compressed document image is then stored in a local memory 26. The stored image is then transferred from the scanner 16 to the computer 30 via a universal serial bus (USB) port 17.

Next, the computer 30 processes the stored document image in an attempt to identify the value of each of the value characters of the stored document image.

The image of each value character is transferred, in turn, from memory 26 within the scanner to a reference point location circuit 32 within the computer 30. The circuit 32 locates a reference point on each value character such that each of the stored templates can be placed over the image in the correct position.

That occurs in a template comparison circuit 36, which is connected to the reference point locator circuit 32 and to the template memory 34. The template comparison circuit 36 is also connected to a scoring circuit 38. The template comparison 36 and scoring circuit 38 function together as a means for identifying each value character image through the use of optical character recognition by comparing the stored templates and the value character images. The system 10 is tolerant to variation of image contrast that is often apparent on soiled currencies.

The output from the scoring circuit 38 is fed to the template selecting circuit 36. The circuit 38 functions as a means for selecting the template with the highest degree of match with the value character image under consideration. The value of the selected template is stored in a local storage memory 40, which is part of the hard drive of the computer 30. The value of the selected template is stored in ASCII format. When the value data is not identified, the document image is stored for viewing and manual reconciliation purposes.

For non-currency documents, the bar-coded validation number 14 is also ascertained from the stored document image and converted into validation data representative of the validation number 14. The system 10 is self adapting for identifying 12-18 digit bar-coded numbers and barcode standards. The validation data is transferred to and stored in local storage memory 40. A clock circuit 42 provides the local storage memory with data representative of the date. The value data, the validation data and the date data for each document are stored together in a file in local memory 40. When the value data is not identified, the stored document image remains in the local memory 40 for viewing and manual reconciliation.

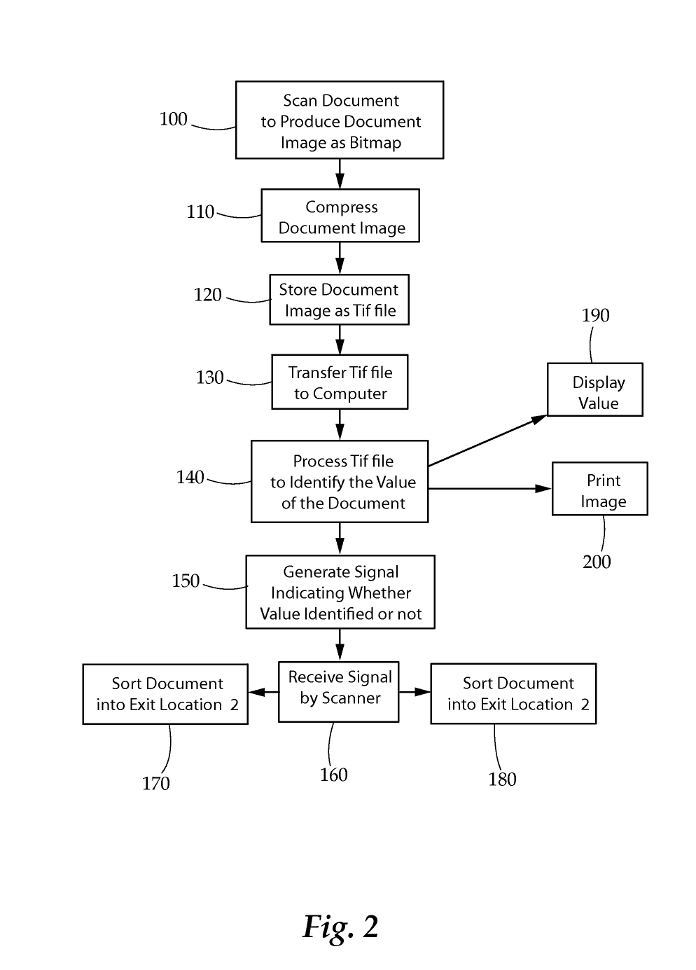

As the steps in FIG. 2 illustrate, the computer 30 generates, in turn, a signal for each file and/or image stored in the local memory 40. Specifically, the signal indicates whether the values of each value characters of the stored image are identified or not.

A control board 28 within the scanner 16 monitors the sensors 19, motors 21 and the scanner display 23. The control board 28 is connected to a graphical user interface (GUI) or display 60 via a serial interface for fortifying communication between the display 60 and scanner 16.

The control board 28 includes a means for monitoring changes in performance of the scanner, preferably by the sensors 19 and motors 21. The control board 28 then includes a means for generating signals related to the changes in performance and a means for transmitting the signals from the scanner to the computer. The control board 28 acts in duplex, or bi-directional, communication with the computer 30 for sending and receiving messages back and forth via the serial interface. The GUI together with the processor of the computer function as a means for receiving the signals from the control board of the scanner, analyzing the signals to define a result or action, and displaying the result or control the action. Messages sent from the computer 30 to the scanner may be displayed directly on the scanner display 23.

The control board 28 functions as a means for sorting each document after the computer attempts to identify the value of the value characters. Specifically, the control board 28 sorts the document into the first exit location 20A when the value characters of the stored image are identified and into the second exit location 20B when the value characters are not identified. Documents that are rejected by the system as unidentified and discarded into the second exit location 20B can be re-deposited into the entrance hopper for rescanning. The value and quantity data for the re-deposited documents will be included in the totals displayed by the system without having to input the entire stack of documents again.

Each document image having value characters not identified by the comparator 36 may be selectively viewed on the display 60. A user is able to view the stored document image and input the value data using a keyboard 55. The keyboard 55 functions as a means for manually entering the value data for value characters not automatically identified by the computer. After manually inputting the value data, the validation data and the date data for each document are stored together in a file in local memory 40.

The computer 30 includes a processor 44, which functions as a means for processing the stored values to display balance information. The balance information may selectively include a total value for currency notes deposited, a total value for slot tickets deposited and a total value of all documents deposited within the entrance hopper 18. The processor 44 accesses the files within the local memory 40 and processes the value data to display balance information. For example, balance information may include, but is not limited to, daily or date balance totals, account or batch balance totals, and/or type of document or currency balance totals. The processor 44 also utilizes stored files within the memory 40 to process quantities of documents scanned and identified. Specifically, the quantity of documents deposited and type of documents deposited are processed for displaying a total quantity of currency notes deposited verse a total quantity of slot tickets deposited. The processor 44 also utilizes stored files and stored images to determine how many, and what kind, of documents have not been automatically identified, taking into consideration all values manually reconciled. In particular, the processor 44 may calculate for display, the total quantity of currency notes deposited having data value characters not identified, a total quantity of slot tickets deposited having data value characters not identified and a total value of all documents deposited having data value characters not identified.

The processor 44 is capable of being programmed to calculate a variety of different balance information data and generating a variety of difference reports customizable to the user and not limited to the aforementioned details. All of the data stored within the memory 40 is available for viewing on the display 60 in a variety of different formats, including by date, deposit run, account or gaming machine.

A printer 50 is in communication with the computer 30, for selectively printing the value data, stored images, balance information, or reports. The computer 30 may forward the stored value data or stored document images to a remote location via the Internet or other network for storage and use at a later time.

In conclusion, herein is presented the system for high speed processing and sorting of documents related to gaming. The invention is illustrated by example in the drawing figures, and throughout the written description. It should be understood that numerous variations are possible, while adhering to the inventive concept. Such variations are contemplated as being a part of the present invention. While only one preferred embodiment of the present invention has been disclosed for purposes of illustration, it is obvious that many modifications and variations could be made thereto. It is intended to cover all of those modifications and variations, which fall within the scope of the present invention as defined by the following claims.

I claim:

1. A method for automatically processing documents, including currency notes and slot tickets related to gaming, of the type having value characters printed on a side thereof, using a scanner having first and second exit locations and operating in duplex communication with a computer, the method comprising the steps of:
a. depositing a stack of documents within the scanner;
b. scanning the printed side of the document;
c. storing an image of the scanned printed side of each document including the value characters;
d. compressing the document image within the scanner;
e. storing the compressed document image within the scanner;
f. transferring the stored image from the scanner to the computer;
g. processing the stored image by the computer to identify the value of each of the value characters of the compressed document image;
h. generating signals by the computer indicating whether the value characters of the stored document image are identified or not identified;
i. transmitting said signals from the computer to the scanner;
j. receiving said signals by the scanner indicating whether the value characters of the stored image are identified or not identified; and
k. sorting the documents in a selected one of a first exit location, when the value characters of the stored document image are identified, and a second exit location, when the value characters are not identified.

2. The method of claim 1 wherein the step of depositing a stack of documents within the scanner comprises repeating steps (a) through (j) with documents sorted into the second exit location when the value is not identified.

3. The method of claim 1 wherein the step of processing the stored image by the computer comprises the step of storing each of the document images when the data value characters are not identified.

4. The method of claim 3 further comprising the steps of: viewing each stored image when the data value characters are not identified; and reconciling each document image by manually entering the value of each data value character not identified.

5. The method of claim 4 further comprising the step of storing the value of each value character identified and each value character manually entered.

6. The method of claim 5 further comprising the step of displaying the stored values of each of the value characters.

7. The method of claim 6 further comprising the step of processing the stored values to display balance information including a total value for currency notes deposited, a total value for slot tickets deposited and a total value of all documents deposited.

8. The method of claim 5 further comprising the step of displaying a total quantity of currency notes deposited, a total quantity of slot tickets deposited and a total value of all documents deposited.

9. The method of claim 8 further comprising displaying a total quantity of currency notes deposited having data value characters not identified, a total quantity of slot tickets deposited having data value characters not identified and a total value of all documents deposited having data value characters not identified.

10. The method of claim 1 wherein the step of storing an image of the printed side of each document including the value characters further comprises the step of formatting the document image as a Bitmap.

11. The method of claim 1 wherein the step of compressing the document image within the scanner comprises the step of compressing the document image as a TIF file.

12. The method of claim 1 wherein the step of storing the compressed document image within the scanner comprises the step of storing the TIF file.

13. The method of claim 1 wherein the step of transferring the compressed document image from the scanner to the computer comprises transferring the compressed document image via a universal serial bus port.

14. The method of claim 1 wherein the step of transmitting the signals from the computer to the scanner comprises transmitting the signals from the computer to the scanner via a serial interface.

15. The method of claim 1 further comprising the step of programming the computer to recognize new currencies.

16. The method of claim 1 wherein the document has a bar coded validation number printed thereon and further comprising the steps of: scanning an image of the validation number from the document; compressing the document image; saving the compressed document image; transferring the document image to the computer; converting the read validation number into validation data representative thereof; and storing the validation data.

17. The method of claim 14 further comprising the step of programming the computer to recognize and read new slot ticket fonts and bar code validation numbers.

18. The method of claim 1 wherein the scanner includes a control board and further comprising the steps of: monitoring changes in performance of the scanner by the control board; generating signals related to the changes in performance by the control board; and transmitting the signals from the control board of the scanner to the computer.

19. The method of claim 18 further comprising the steps of: receiving the signals from the control board by the computer; analyzing the signals to define a result; and displaying said result.

20. A system for automatically processing documents including currency notes and slot tickets related to gaming, of the type having value characters printed on a side thereof, comprising:
a scanner terminal including an entrance hopper into which a stack of currency notes and slot tickets are deposited and first and second exit locations out of which currency notes and slot tickets are sorted, means for scanning the printed side of the document, means for storing an image of the scanned printed side of each document including the value characters, means for compressing the document image, means for storing the compressed document image, means for transferring the compressed document image, means for receiving a signals indicating whether the value characters of the stored image are identified or not identified, and means for sorting the documents in a selected one of a first exit location, when the value characters of the stored document image are identified, and a second exit location, when the value characters are not identified; and
a computer in duplex communication with said scanner including means for receiving the compressed document image, means for processing the stored image to identify the value of each of the value characters, means for generating signals indicating whether the stored image is identified or not identified, and means for transmitting the signals to the scanner.

21. The system of claim 20 wherein at least one document from the second exit location is re-deposited into the entrance hopper.

22. The system of claim 20 wherein said means for processing the stored image by the computer comprises means for storing each of the document images when the data value characters are not identified.

23. The system of claim 22 further comprising means for viewing each stored image when the data value characters are not identified, and means for reconciling each document image by manually entering the value of each data value character not identified.

24. The system of claim 23 further comprising means for storing the value of each value character identified and each value character manually entered.

25. The system of claim 24 further comprising means for displaying the stored values of each of the value characters.

26. The system of claim 25 further comprising means for processing the stored values to display balance information including a total value for currency notes deposited, a total value for slot tickets deposited and a total value of all documents deposited.

27. The system of claim 24 further comprising means for displaying a total quantity of currency notes deposited, a total quantity of slot tickets deposited and a total value of all documents deposited.

28. The system of claim 27 further comprising means for displaying a total quantity of currency notes deposited having data value characters not identified, a total quantity of slot tickets deposited having data value characters not identified and a total value of all documents deposited having data value characters not identified.

29. The system of claim 20 wherein means for storing an image of the scanned printed side of each document including the value characters further comprises means for formatting the document image as a Bitmap.

30. The system of claim 20 wherein means for compressing the document image within the scanner comprises means for compressing the document image as a TIF file.

31. The system of claim 20 wherein means for storing the compressed document image within the scanner comprises means for storing the TIF file.

32. The system of claim 20 wherein means for transferring the compressed document image from the scanner to the computer comprises means for transferring the compressed document image via a universal serial bus port.

33. The system of claim 20 wherein means for transmitting the signals from the computer to the scanner comprises means for transmitting the signals from the computer to the scanner via a serial interface.

34. The system of claim 20 further comprising means for programming the computer to recognize new currencies.

35. The system of claim 20 wherein the document has a bar coded validation number printed thereon and further comprising means for scanning an image of the validation number from the document, means for compressing the document image, means for saving the compressed document image, means for transferring the document image to the computer, means for converting the read validation number into validation data representative thereof, and means for storing the validation data.

36. The system of claim 33 further comprising means for programming the computer for recognizing and reading new slot ticket fonts and bar code validation numbers.

37. The system of claim 20 wherein the scanner includes a control board and further comprising: means for monitoring changes in performance of the scanner by the control board; means for generating signals related to the changes in performance by the control board; and means for transmitting the signals from the scanner to the computer.

38. The system of claim 37 further comprising: means for receiving the signals by the computer; means for analyzing the signals to define a result; and means for displaying the result.
